(19) United States
(12) Patent Application Publication
(10) Pub. No.: US 2008/0132300 A1
(43) Pub. Date: Jun. 5, 2008

(54) METHOD AND APPARATUS FOR CONTROLLING OPERATION OF A PORTABLE DEVICE BY MOVEMENT OF A FLIP PORTION OF THE DEVICE

(75) Inventors: EDWARD L. GILMORE, Sunrise, FL (US); Luis A. Pichardo, Miramar, FL (US)

Correspondence Address: MOTOROLA, INC, 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 11/733,276

(22) Filed: Apr. 10, 2007

Related U.S. Application Data
(60) Provisional application No. 60/867,968, filed on Nov. 30, 2006.

(51) Int. Cl. H04M 1/00

(52) U.S. Cl. 455/575.3

(57) ABSTRACT

A portable device has a main body portion (102) and a flip portion (104). The flip portion is moveable between a closed position (100) and an open position (200). The position of the flip portion is detected by a position detecting circuit (524, 526). When the flip portion is moved in a pre-defined or prescribed manner, the device identifies the movement as user input for adjusting or controlling operation of the device.

### CROSS-REFERENCE TO RELATED APPLICATION

The present application claims the benefit of U.S. Provisional Application No. 60/867,968, filed Nov. 30, 2006, which is hereby incorporated by reference thereto.

### FIELD OF THE INVENTION

The invention relates generally to portable electronic devices comprised of two main body portions, where the body portions are moveable relative to each other, and more specifically to controlling operation of an electronic device by movement of the body portions.

### BACKGROUND OF THE INVENTION

Portable hand-held electronic devices are in widespread use and provide a variety of functions. Most notably, mobile communication devices are constantly being designed with an increased number of features, making voice communication just one of the many functions they provide to users. As such, these devices are increasingly relied upon by people in everyday life.

Despite the increased functionality expected of such devices, they continue to remain relatively small. This has presented a problem to manufactures because with increased functionality there has been a corresponding need to provide a variety of user input. For example, many users dislike using a conventional telephony keypad for text entry, and in response manufacturers have sought to provide “QWERTY” style keypads. Such “full” keypads, however, require a substantial surface area. In response, manufactures have, for example, designed wider devices to accommodate a full keypad, or provided a retractable or sliding body section that can be hidden when not in use.

Full keypads help users enter text into a device, but devices now run applications using other types of input to control. Manufacturers have provided navigation buttons for directional input, for example. Adding buttons of course requires more area, which tends to work against designing a small device. Therefore there exists a need for a means to provide user input to control operation of a portable device without having to add additional buttons.

### SUMMARY OF THE INVENTION

The present invention discloses in an embodiment a method for controlling operation of an application running on a mobile communication device. The mobile communication device is designed with a main body portion and a flip portion, otherwise known as a “clamshell” configuration. The flip portion may have a display, and is moveable between a closed position and a fully open position. In a present embodiment, the application present or outputs graphical information on the display. The inventive method embodiment commences by initiating a positional input mode of the mobile communication device. As the flip portion is moved, the method commences detecting the flip being in an intermediate position between the closed and fully open positions, and then adjusting operation of the application in correspondence with the intermediate position.

In a further embodiment the invention provides a method of operating a user interface of a portable device, the device having a main body portion and a flip portion. The main body portion and the flip portion are coupled together at a hinge. The flip portion is moveable between a closed position and a fully open position. The present method embodiment commences upon opening the flip portion to the fully open position, and then moving the flip in a prescribed motion. The device detects the prescribed motion of the flip, and subsequently commences a prescribed operation of the portable device which corresponds to the prescribed motion of the flip portion.

In a further embodiment of the invention there is provided a mobile communication device, comprised of a main body portion and a flip portion which is coupled to the main body portion and is moveable between a closed position and a fully open position. The mobile communication device further includes a position detecting circuit operatively coupled to the main body portion and the flip portion which provides an output for indicating a position of the flip portion relative to the main body portion. A processor of the mobile communication device, which is operatively coupled to the position detecting circuit, is configured to adjust an operation of the mobile communication device when the flip is moved in a prescribed manner, as detected by the position detecting circuit.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 shows a side view of a portable folding electronic device in a closed position, in accordance with an embodiment of the invention;

FIG. 2 shows a side view of a portable folding electronic device in a fully open position, in accordance with an embodiment of the invention;

FIG. 3 shows a side view of a portable folding electronic device in an intermediate position, in accordance with an embodiment of the invention;

FIG. 4 shows an isometric view of a portable folding electronic device in an intermediate position, in accordance with an embodiment of the invention;

FIG. 5 shows a block schematic diagram of a portable device, in accordance with an embodiment of the invention; and

FIG. 6 shows a flow chart diagram of a method of operating a folding portable electronic device, in accordance with an embodiment of the invention.

### DETAILED DESCRIPTION OF THE INVENTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

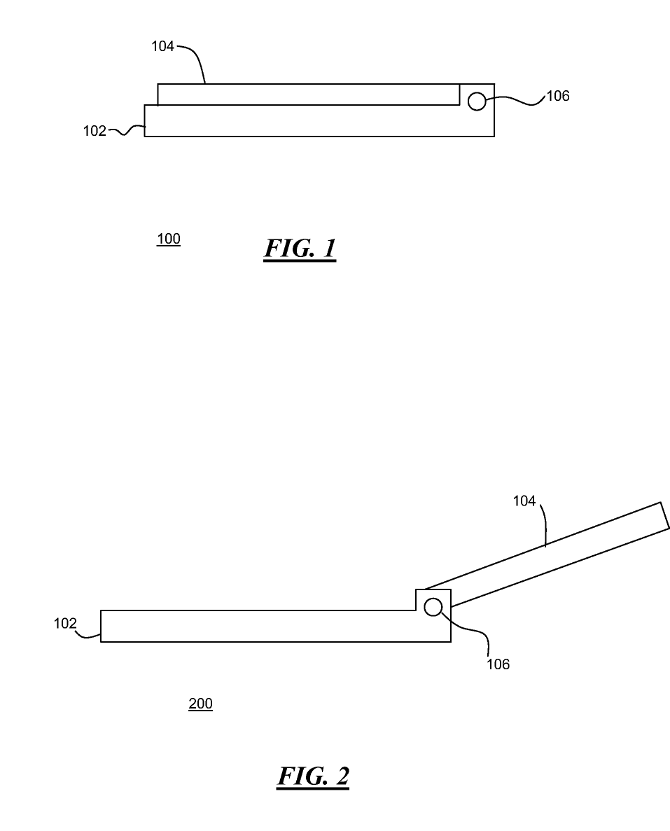

Referring now to FIG. 1, there is shown a side view of a portable folding electronic device in a closed position 100, in accordance with an embodiment of the invention. The device may be any number of devices for a variety of function, although it is contemplated that the inventive methods and apparatus disclosed herein are particularly suited for use with a folding mobile communication device or cellular telephone. The folding design is a commonly design in mobile communication devices, and allows a keypad to be positioned in the main body portion and a display in the flip portion. When the device is in use and the flip is closed, as shown in the present figure, the flip covers the keypad and prevents accidental key presses.

The device has a main body portion 102 and a flip portion 104. The main body portion and flip portion are hingeably connected at a hinge 106, allowing the body portions to move with respect to each other. The hinge can be implemented by any conventional design, as are well-practiced in the art. Electronic circuitry disposed in the main body portion is electrically coupled to circuitry in the flip portion by, for example, a flexible circuit board member that passes through the hinge. In the closed position, the device is generally in an idle state, waiting to be opened and used by a user, or waiting to receive a call notification from a communication system to which the user subscribes.

FIG. 2 shows the device in a fully open position 200. In the open position the user may access a keypad, view a display, make and receive calls, and so on. Conventionally, the flip is either in the closed position or the fully open position, and the hinge typically includes springs and other means for biasing the flip into either of those positions. Thus, when the device is in the closed position, the biasing means tends to hold the flip portion in the closed position, although it allows a user to easily open the flip to the open position, where, like the closed position, the flip is biased into the full open position.

While in the open position, where a main display may be viewed by the user, the device can run various applications, such as, for example, Internet web browsers, media viewers, games, email clients, datebooks, and so on. As is well known, the device presents the user with an interface from which the user can launch applications or undertake other operations. Control of these operations and input to applications is typically accomplished by pressing buttons on the device, or by voice commands in some cases.

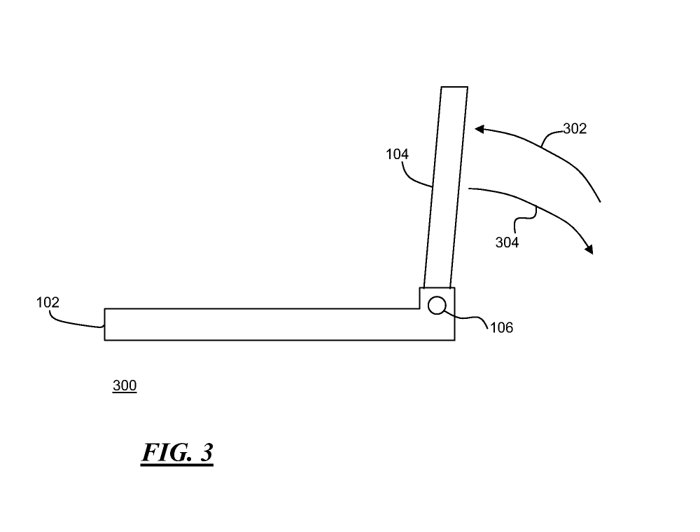

Referring now to FIG. 3, there is shown a side view of a portable folding electronic device in an intermediate position 300, in accordance with an embodiment of the invention. Although any flip-type device, when moving the flip from the closed position to the fully open position, or vice versa, requires movement of the flip through intermediate positions, according to the present invention, the instance of being at an intermediate position, and a specific range of intermediate position, is detected, and used as the basis for controlling operation of the device or an application running on the device. Thus, upon opening the device and launching an application, the user of the device may move the flip to an intermediate position, as shown, between the closed and fully open positions, as indicated by arrow 302. The position may be detected by use of a position sensor disposed, for example, in the hinge portion of the device. Upon the flip portion being moved to a specific or prescribed position, as detected by the position sensor, an input event is generated and provided to the instantiated application, which undertakes a prescribed action in response.

Movement of the flip to the prescribed position may be part of a more complex movement. For example, the flip may be moved to the intermediate position momentarily, and returned to the fully open position as a “rocking” motion, as indicated by arrow 304. In such a case, detection of the flip in the intermediate position is simply part of detecting a movement of the flip in a prescribed manner. It is also contemplated that there may be more than one prescribed position may be defined, with each prescribed position of movement corresponding to a different input. For example, moving the flip from an intermediate position to the open position and back to the intermediate position could correspond to a “go back” command for a web browser, while moving the flip forward, towards the closed position, and back could correspond to a “go forward” command. Similarly, with a video player application, one movement could be used for “fast forward” and another movement could be used for “rewind.”

Furthermore, upon detecting the flip being moved into the prescribed position or in the prescribed manner, the device may provide feedback to the user to confirm that the device has detected the movement. The feedback may be tactile, such as by momentarily turning on a vibrator motor, as well as audible or visual. And if multiple prescribed movements are defined, the feedback may vary to correspond to each of the defined prescribed positions or movements.

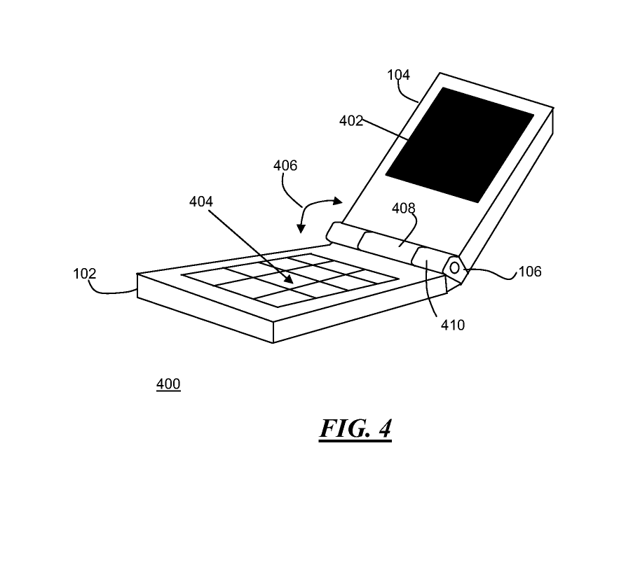

Referring now to FIG. 4, there is shown an isometric view of a portable folding electronic device in an intermediate position 400, in accordance with an embodiment of the invention. As shown here, the device may be substantially the same as that shown in FIGS. 1-3. The device has a main body portion 102, and a flip portion 104 coupled by a hinge 106. The flip portion typically contains a display 402 for presenting visual information and media to the user. Alternatively, the display may be located on the main body portion, given sufficient space. The main body portion contains an input means such as, for example, a keypad 404 and other buttons, which may include navigational buttons or elements for controlling a cursor shown on the display, or for controlling scrolling of media presented on the display. As in FIGS. 1-3, the flip portion is moveable, as indicated by double arrow 406. The hinge portion of the device includes a flip hinge portion 408 and one or more main body hinge portions 410. The flip hinge portion may be integrally formed with the flip portion, and the main body hinge portion may be integrally formed with the main body portion.

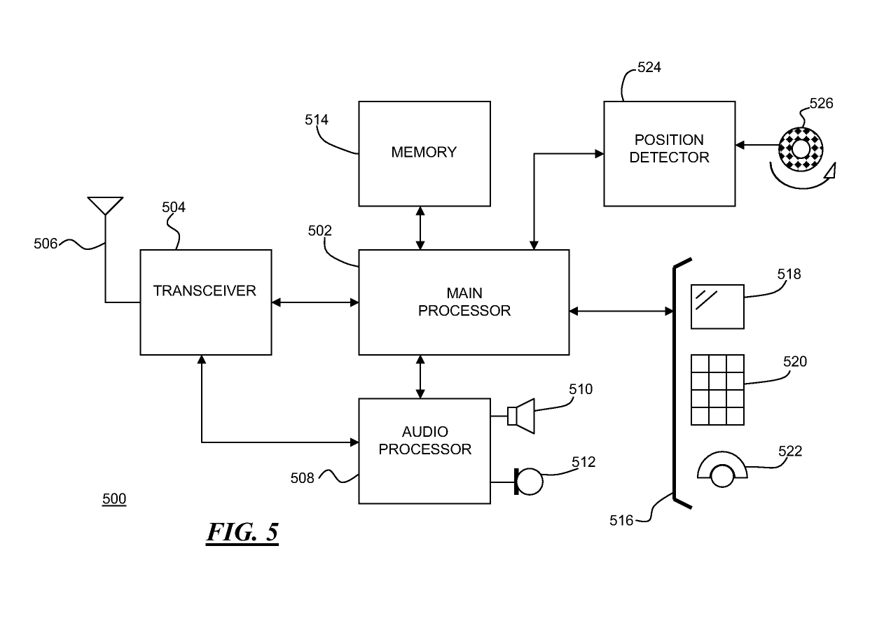

Referring now to FIG. 5, there is shown a block schematic diagram of a portable device 500, in accordance with an embodiment of the invention. The device shown is an example of a mobile communication device, but could be any of a number of devices, as those skilled in the art will appreciate. The blocks shown here are abstracted at a high level and will include various hardware elements, software elements, or both, and they may be implemented in a variety of ways.

The device includes a main processor 502, which executes instruction code designed in accordance with the teachings herein. In the present example, the processor is operatively coupled to a radio frequency transceiver. The transceiver includes all necessary elements for modulating, demodulating, transmitting, receiving, filtering, amplifying, and other processing of signals that are to be transmitted and that have been received via an antenna 506. The transceiver and main processor are both operatively coupled to an audio processor 508. The audio processor performs operations on audio signals so that audio signals received form a remote location via the transceiver may be played over a speaker 510, and audio signals received locally at a microphone 512 may be processed for transmission by the transceiver the device further includes an aggregate memory 514 which may include read only memory, random access memory, volatile and non-volatile memory, storage memory and execution memory. The device uses various memory elements to store instruction code for operating systems, applications, firmware, data, and so on. The combination of the memory and the executable instruction code configures the processor to accomplish the various methods, processes, and tasks for which the device is intended. For example, the instruction code, along with certain hardware elements, allow the processor to operate a user interface 516. The interface may include elements such as a display 518, keypad and other buttons 520, speakers 510, and tactile feedback elements such as a vibrational motor 522. The vibrational motor is an electric motor that drives an eccentric cam to produce vibrations.

The device further comprises, as part of its user interface, a positional detector 524 that is operatively coupled to the processor 502. The position detector is further coupled to a position sensor 526 which produces an output as the flip portion of the device is moved. The output of the position sensor is processed by the position detector, which determines when the flip is in a prescribed position or has been moved in a prescribed manner. The position detector may be an independent hardware element, or it may be a software element running on the main processor. The position sensor includes hardware elements which produce an electric signal indicating movement of the flip, position of the flip, or both. The position sensor may be, for example, a resistive potentiometer which changes electrical resistance as the flip is moved. Another example of a position sensor may include an opto-electric device which detects motion by the breaking of an optical coupling. In a further example, the position sensor may include a series of small magnets disposed in either the flip portion or the main body portion of the hinge, and a hall effect device disposed in the other body portion such that as the flip is rotated, the hall effect device senses the magnetic pulses as the magnets move past it.

As the flip portion is moved and the flip hinge portion 408 moves past the main body hinge portion 410. The position sensor 526 may have elements disposed in both portions for detecting the motion. The movement of the flip portion results in the position sensor generating a signal to the position detector 524, which tracks the signal and compares it to predefined patterns corresponding to one or more prescribed positions or prescribed movements. Once a prescribed position or movement is detected, the position detector may interrupt the processor 502 to indicate the occurrence of the prescribed position or motion. Subsequently, the processor provides the movement information to an instantiated application as a user input, and the application then adjusts its operation accordingly.

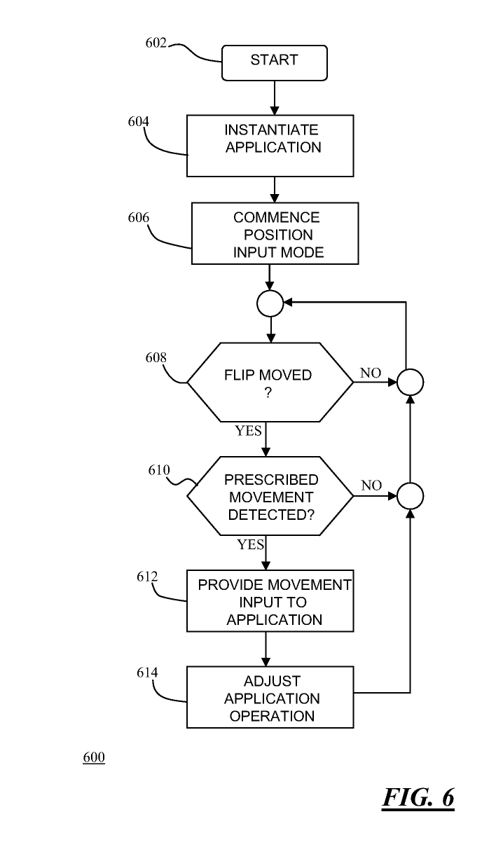

Referring now to FIG. 6, there is shown a flow chart diagram of a method of operating a folding portable electronic device 600, in accordance with an embodiment of the invention. At the start 602, the device is powered on and ready for operation. Typically the device has been closed and is presently opened to the fully open position. It should be noted that by “fully open” it is meant only a defined positional boundary with respect to the movement range of the flip portion. That may or may not be the full mechanical limit to which the flip portion may be opened. It is contemplated that different applications may, for example, define the fully open position to be different positions from application to application, or under various different contexts. Once the flip portion is opened, an application is then instantiated 604. The application may be instantiated at the command of the user, who may, for example, select an application to run, or the application may be automatically instantiated by virtue of opening the flip portion, such as may be the case with a user interface element of the device, or some other application. Upon instantiating the application, the device then commences a positional input mode 606 to observe, track, or otherwise measure movement of the flip portion. The positional input mode may be selected by the user as an optional input mode, or it may be automatically commenced by the application. Furthermore, actual sensing of the flip position may occur only upon sensing the flip portion being moved from a preset position, such as the fully open position.

Once the device detects movement of the flip portion 608, the device then tracks the movement to determine if the flip is either moved to a prescribed position or in a prescribed manner 610. If the position detector indicates the flip portion has been moved in a prescribed manner, then an input corresponding to the detected prescribed motion is provided to the application 612. Upon receiving the input, the application then adjusts its operation in a manner corresponding to the detected movement, as defined by the application. As indicated by the flow chart, the method may be constantly repeating to provide various input to the application. Alternatively, it is contemplated that the device may be a multi-mode communication device capable of communicating by one of several modes of communication including, for example, cellular telephony, or simplex dispatch communication either network assisted or direct communication. Furthermore, several modes of cellular telephony communication may be available, such as code division multiple access (CDMA), time division multiple access (TDMA) such as that described by the Global System for Mobile communication (GSM) specification. In such a multi-mode communication device, it is contemplated that movement of the flip portion in a prescribed manner may be used to toggle the active communication mode. It is further contemplated that the invention may be used to accept or reject incoming calls. Upon receiving notification of an incoming call the user may open the device, or the device may already be opened as the user may be engaged in another activity. The user may, for example, “rock” the flip portion once to accept the incoming call, and “rock” the flip twice in succession to reject the call. Other motions of the flip portion may be defined to either reject or accept an incoming call.

In addition to the detection of the position of the flip portion, or movement of the flip portion in a prescribed manner, the invention may further be used to detect the degree of movement away from a prescribed position, and the direction of movement away from the prescribed position. For example, consider a game application simulating control of a vehicle. Movement of the flip portion can be detected to correspond to a speed at which the simulated vehicle moves in its virtual environment. Furthermore, movement back and forth may be used, for example, to cause a simulated object to move back and forth on the screen. In another example, the degree and direction of movement of the flip portion may be used to control speed and direction of scrolling through a list or other media or visual information displayed on the display.

This invention can be embodied in other forms without departing from the spirit or essential attributes thereof. Accordingly, reference should be made to the following claims, rather than to the foregoing specification, as indicating the scope of the invention.

What is claimed is:

1. A method for controlling operation of an application running on a mobile communication device, the mobile communication device having a main body portion and a flip portion, the flip portion having a display and moveable between a closed position and a fully open position, the application outputting graphical information on the display, the method comprising:
initiating a positional input mode of the mobile communication device;
detecting the flip being in an intermediate position between the closed and fully open positions; and
adjusting operation of the application in correspondence with the intermediate position.

2. A method for controlling operation of an application as defined in claim 1, wherein initiating the positional input mode occurs upon instantiation of the application.

3. A method for controlling operation of an application as defined in claim 1, further comprising providing a perceptible feedback to a user of the mobile communication device when the flip is at the intermediate position.

4. A method for controlling operation of an application as defined in claim 3, wherein providing perceptible feedback includes providing tactile feedback.

5. A method for controlling operation of an application as defined in claim 3, wherein providing perceptible feedback includes providing audible feedback.

6. A method for controlling operation of an application as defined in claim 1, wherein detecting the flip being in the intermediate position comprises detecting the flip moving from the intermediate position to a different position.

7. A method for controlling operation of an application as defined in claim 1, wherein the application is a media player, the media player performing playback of a media file, adjusting operation of the application comprises adjusting a playback operation.

8. A method for controlling operation of an application as defined in claim 1, wherein the application is an Internet browser, adjusting operation of the application comprises performing a browser operation.

9. A method for controlling operation of an application as defined in claim 1, wherein the application is a user interface application for controlling a user interface of the mobile communication device, adjusting operation of the application comprises adjusting an aspect of the user interface.

10. A method for controlling operation of an application as defined in claim 9, wherein adjusting an aspect of the user interface comprises toggling a communication mode readiness state of the mobile communication device.

11. A method of operating a user interface of a portable device having a main body portion and a flip portion, the main body portion and flip portion coupled together at a hinge, the flip portion moveable between a closed position and a fully open position, the method comprising:
opening the flip portion to the fully open position;
moving the flip in a prescribed motion;
detecting the prescribed motion of the flip; and
commencing a prescribed operation of the portable device, the prescribed operation corresponding to the prescribed motion.

12. A method of operating a user interface of a portable device as defined in claim 11, wherein the prescribed motion comprises:
moving the flip to an intermediate position between the closed and fully open positions;
holding the flip at the intermediate position momentarily; and
moving the flip back to the fully open position.

13. A method of operating a user interface of a portable device as defined in claim 12, further comprising providing tactile feedback upon detecting the prescribed motion.

14. A method of operating a user interface of a portable device as defined in claim 11, wherein commencing the prescribed operation comprises adjusting playback of a media player application of the portable device.

15. A method of operating a user interface of a portable device as defined in claim 11, wherein commencing the prescribed operation comprises toggling a communication mode readiness state of the portable device.

16. A mobile communication device, comprising:
a main body portion;
a flip portion hingeably coupled to the main body portion and moveable between a closed position and a fully open position;
a position detecting circuit operatively coupled to the main body portion and the flip portion and providing an output for indicating a position of the flip portion relative to the main body portion; and
a processor operatively coupled to the position detecting circuit and configured to adjust an operation of the mobile communication device when the flip is moved in a prescribed manner as detected by the position detecting circuit.

17. A mobile communication device as defined in claim 16, wherein the processor is further configured to provide a perceptible feedback to a user of the mobile communication device upon the flip being moved in the prescribed manner, and the mobile communication device further comprises at least one user interface element for providing the perceptible feedback.

18. A mobile communication device as defined in claim 16, wherein the processor is further configured to change a present communication mode of the mobile communication device.

19. A mobile communication device as defined in claim 16, wherein the processor is further configured to adjust video playback operation when the flip is moved in the prescribed manner as detected by the position detecting circuit.

20. A mobile communication device as defined in claim 16, wherein the processor is further configured to adjust an Internet web browser operation of the mobile communication device when the flip is moved in the prescribed manner as detected by the position detecting circuit.
